(19) United States
(12) Patent Application Publication
(10) Pub. No.: US 2003/0125979 A1
(43) Pub. Date: Jul. 3, 2003

(54) Method for flexible definition and retrieval of behavioral data applicable to multiple participating parties

(76) Inventors: Mary K. Dangler, Rochester, MN (US); Richard Addison Benson, Ventura, CA (US)

Correspondence Address: RATNERPRESTIA, P O BOX 980, VALLEY FORGE, PA, 19482-0980, US

(21) Appl. No.: 10/315,481

(22) Filed: Dec. 9, 2002

Related U.S. Application Data
(60) Provisional application No. 60/340,517, filed on Dec. 13, 2001.

(51) Int. Cl. G06F 17/60

(52) U.S. Cl. 705/1

(57) ABSTRACT

A method for guiding the decision making process prior to a company entering into an agreement, or engaging in a transaction, or conducting a business event. Policies, factors, weights, and relative priorities for the factors are established for each kind of agreement, transaction or event. Later, the established factors are retrieved and they are operated upon in accordance with an algorithm.

### CROSS REFERENCE TO RELATED APPLICATION

This application claims the benefit under Title 35 U.S.C. §119(e) of U.S. Provisional Application No. 60/340,517 filed on Dec. 13, 2001, the contents of which are incorporated herein by reference.

### FIELD OF THE INVENTION

The present invention relates generally to online transactions and more particularly to the manner of guiding the decision making process prior to a company entering into an agreement, or engaging in a transaction, or conducting a business event.

### BRIEF DESCRIPTION OF THE PRIOR ART

In any organization, decision makers often have a need to consider, often simultaneously, a large number of factors, to establish relative weights to the factors, and to establish relative priorities to the factors.

Up until now, the decision making process required the decision makers to make decisions in an uncontrolled, unguided, haphazard fashion without the ability to use pre-established, yet flexible factors to guide them. Decision making has required the decision-maker to think of the factors to be considered on an ad hoc basis and to interweave the factors as the decision-maker saw fit at the time of the decision. Often, under the need to make a decision quickly, necessary factors were not considered and the weights and priorities given to particular factors were inadequate or otherwise faulty for the particular problem being addressed. Decisions made quickly under stress did not create an efficient, reliable, and consistent method of decision-making

Accordingly, there is a need for a system that allows a decision-maker to efficiently, accurately, and effectively engage in a structured, yet flexible, decision-making process.

### SUMMARY OF THE INVENTION

The present invention is directed to method for guiding decision making related to at least one business operation. The method comprises the steps of retrieving at least one business policy for at least one business operation; determining and retrieving established factors and established relative weights assigned to the established factors for the at least one business operation; and operating upon the retrieved at least one business policy, the established factors, and the established relative weights in accordance with an algorithm.

### BRIEF DESCRIPTION OF THE DRAWINGS

FIG. 1 is a flow chart showing the steps for establishing a business policy for a particular business role.

FIG. 2 is a flow chart showing the decision-making process in Step 1 of the steps for establishing a business policy for a particular business role.

FIG. 3 is a flow chart showing the decision-making process in Step 2 of the steps for establishing a business policy for a particular business role.

FIG. 4 is a flow chart showing the decision-making process in Step 3 of the steps for establishing a business policy for a particular business role.

FIG. 5 is a flow chart showing the decision-making process in Step 4 of the steps for establishing a business policy for a particular business role.

FIG. 6 is a flow chart showing the steps for retrieving a business policy for a particular business decision.

FIG. 7 is a flow chart showing the decision-making process in Step 1 of the steps for retrieving a business policy for a particular business decision.

FIG. 8 is a flow chart showing the decision-making process in Step 2 of the steps for retrieving a business policy for a particular business decision.

FIG. 9 is a flow chart showing the decision-making process in Step 2A of the steps for retrieving a business policy for a particular business decision.

FIGS. 10, 10A and 10B are flow charts showing the decision-making process in Step 3 of the steps for retrieving a business policy for a particular business decision.

FIG. 11 is a flow chart showing the decision-making process in Step 3A of the steps for retrieving a business policy for a particular business decision.

FIG. 12 is a flow chart showing the decision making process in Step 4 of the steps for retrieving a business policy for a particular business decision.

FIG. 13 is a table summarizing the concepts underlying the invention.

FIG. 14 is an exemplary embodiment of a computer screen that is presented to a user of the invention that wants to establish default entries for its credit policies.

FIG. 15 is an exemplary embodiment of a computer screen depicting the establishment of values for a credit item.

FIG. 16 is an exemplary embodiment of a computer screen for establishing credit policies for a credit item group.

FIG. 17 is an exemplary embodiment of an establish computer screen for establishing credit policies for a credit customer.

FIG. 18 is an exemplary embodiment of an establish computer screen for establishing credit policies for a credit customer group.

### DETAILED DESCRIPTION OF THE PREFERRED EMBODIMENTS

The present invention is directed to a method for guiding the decision making process prior to a company entering into an agreement, or engaging in a transaction, or conducting a business event. The method can be used in a computer system and in an interactive, computer-implemented system. In carrying out the method, at least one business operation is specified and at least one business policy is established for the at least one business operation. Establishing the at least one business policy includes establishing factors to be considered, establishing relative weights to be assigned to each of the factors, and establishing relative priorities.

Later, the at least one business policy for the at least one business operation is retrieved along with the established factors and the established weights assigned to the factors. The decision making is then guided by an algorithm which operates upon the retrieved at least one business policy, the established factors, and the established relative weights.

In one embodiment of the invention, IBM San Francisco Business Components are used to manage the data in an object oriented manner; the object data is persisted to a relational database. But as will be apparent to those skilled in the art, other data store mechanisms could also be used. For example, other embodiments of the invention could use Enterprise Java Beans or some standard SQL mechanism to store the information.

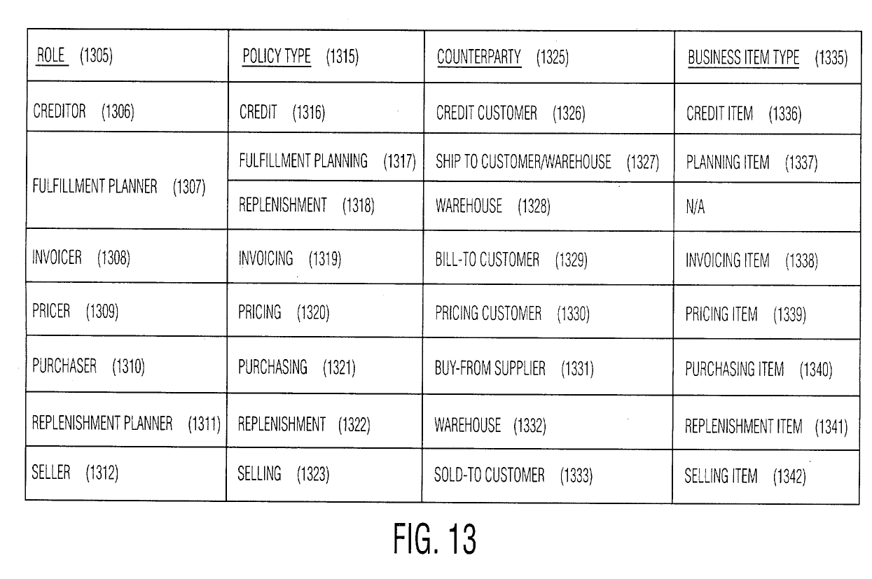

Before explaining a preferred embodiment of the present invention, we will first explain some of the concepts underlying the invention. The concepts are summarized in the table in FIG. 13.

The role of the company using this invention, shown in column 1305, is the first thing to be considered. A company's role may generally be described as a supplier of goods and/or services. More specifically, for example, and without intending to limit the scope of possible roles, when a company supplies credit, it acts in the role of a creditor, 1306; when it plans how to fulfill orders from a customer, it acts in the role of a fulfillment planner, 1307; when it sends invoices to a customer, it acts in the role of an invoicer, 1308; when it sets the price of a product or service, it acts in the role of a pricer, 1309; when it purchases items, it acts in the role of a purchaser, 1310; when it plans how to replenish items, it acts in the role of a replenishment planner, 1311; and when it sells items, it acts in the role of a seller, 1312.

A business policy, shown in block 1315, is a factor (a control), or a set of factors (controls), that determine how a company configures an agreement, performs a transaction, or executes a business event based on its role in the agreement, transaction, or event. The business policy factors determine how a company conducts business of a specific type. Business policies vary by policy type. A company using the business method described herein, first identifies the type of policy it wants to set. In an exemplary embodiment of the invention, the types of policies (policy types) that a company can set pertain to credit, 1316; fulfillment planning, 1317; replenishment (of supplies), 1318; invoicing, 1319; pricing, 1320; purchasing, 1321; and selling, 1323. It will be understood by those skilled in the art that another embodiment of the invention could include other policy types.

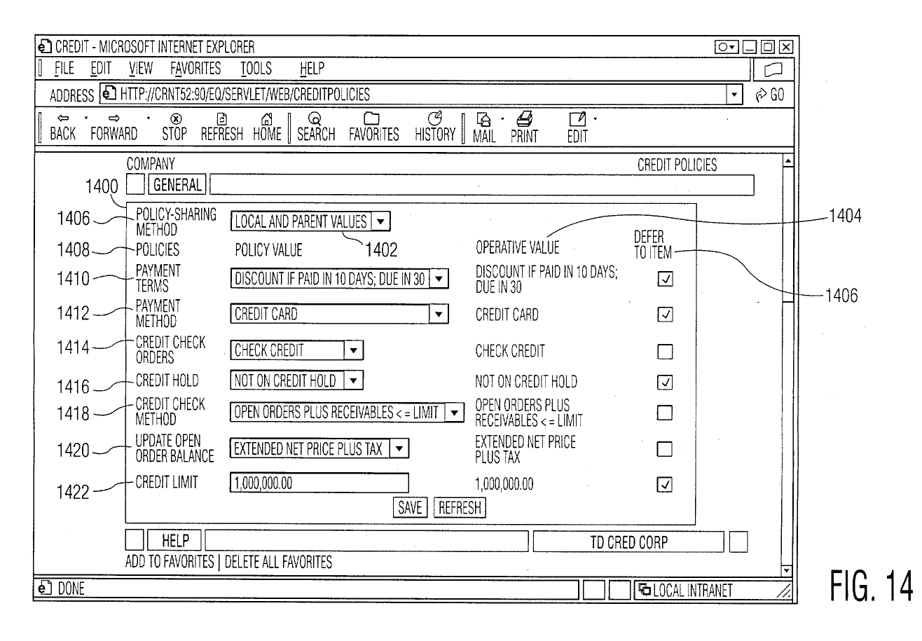

Once the company identifies the policy type it wants to set, an exemplary embodiment identifies a predetermined set of sub-factors, referred to herein as policy values. For example, if a company wants to set its policy for credit, 1316, identifying the policy type as credit will produce a list of seven subfactors (FIG. 14) (policy values) which the company can set. In an exemplary embodiment, the seven policy values, shown in FIG. 14, are payment terms, 1410; payment method, 1412; credit card orders, 1414; credit hold, 1416; credit check method, 1418; update open order balance, 1420; and credit limit, 1422. Identification of the policy values and choosing from among several sub-subfactors identified with each policy value allows the system user to very precisely configure the agreement, perform the transaction, or execute the business event in accordance with the company's established business value for the policy type under consideration. It will be understood by those skilled in the art that the predetermined set of subfactors (policy values) and sub-subfactors for the credit policy type, and for any policy type, can be changed depending upon the needs of the user company.

Generally, each role and policy type has a corresponding business item associated with them. The business item is the product or service being provided by the company corresponding to the role it has assigned to itself and the policy type it has associated with the role. In an exemplary embodiment, the business item type is a credit item, 1336, when the user company is in a creditor role and it is setting credit policy; the business item type is a planning item, 1337, when the user company is in a fulfillment planner role and it is setting fulfillment planning policy; there is no business item type when the user company is in a fulfillment planner role and it is setting replenishment policy; the business item type is an invoicing item, 1338, when the user company is in invoicer role and it is setting invoicing policy; the business item type is a pricing item, 1339, when the user company is in the pricer role and it is setting pricing policy; the business item type is a purchasing item, 1340, when the user company is in the purchaser role and is setting purchasing policy; the business item type is a replenishment item, 1341, when the user company is in the replenishment planner role and is setting replenishment policy; and the business item type is a selling item, 1342, when the user company is in the seller role and setting selling policy. As will be understood by those skilled in the part, other embodiments of the invention could identify other business items types.

For each role undertaken by the user company, there is a counterparty, 1325, which is usually a customer of the user company. However, the counterparty could also be a location, such as a warehouse. A counterparty is the other company or location which the user company will engage during the transaction or event.

When the user company is in the role of a creditor and is setting a credit policy, the counterparty is a credit customer, 1326. When the user company is in the role of a fulfillment planner and is setting a fulfillment planning policy, the counterparty is the customer or the warehouse, 1327, to which the planning item will be shipped. When the user company is in the role of a fulfillment planner and is setting a replenishment policy, the counterparty is the warehouse, 1328, to which the planning item will be sent. When the user company is in the role of an invoicer and is setting an invoicing policy, the counterparty is the customer to whom the bill will be sent, 1329. When the user company is in the role of a pricer and is setting a pricing policy, the counterparty is the pricing customer, 1330. When the user company is in the role of a purchaser and is setting a purchasing policy, the counterparty is the supplier from whom the purchasing item will be bought, 1331. When the user company is in the role of a replenishment planner and is setting a replenishment policy, the counterparty is the warehouse to which the replenishment item will be sent, 1332. When the user company is in the role of a seller and is setting a selling policy, the counterparty is the customer to whom the selling item is sold, 1333.

The process of an exemplary embodiment of the present invention comprises two overall functions: establishing business policies for each role and policy type and retrieving the business policies for a specific transaction after they have been established. After the business policies have been established, they are maintained as default settings in the system until they are changed by an authorized user of the system. The system uses a combination of object-oriented programming and algorithm based programming.

Once these steps are followed and the information is entered for a business policy for a particular business role, the information becomes the default settings for that specific role and specific business policy until they are changed by an authorized person. It is envisioned that the settings will be changed infrequently.

That is, the business policy values assigned by a company to itself represent the default business behavior of the company. For example, when the user company takes the role of a pricer, the pricing policy values assigned by the company to itself represent the default pricing behavior of the company.

Even if the user company does not change the default values, there can be exceptions to the default values. For example, for any particular role selected by the user company, the user company may assign policy values to the corresponding counterparty, to the corresponding business item, or to a counterparty/business item link. When policy values are assigned to any of these latter areas, they represent exceptions to the default business behavior of the user company and will override some or all of the default settings.

The system also allows the user company to create groups of items. Several things may be placed, for example, into a single policy group based on a particular set of criteria. For example, a customer may be a member of a policy group where the policy group is a business group designated to provide policy values for the customer and when no policy value for a specific business policy has been assigned to the customer. As another example, a business item may be a member of a policy group where the policy group is a business group designated to provide policy values for the business item and when no policy value for a specific business policy has been assigned to the business item.

Accordingly, when a customer's policy value for a specific business policy is “No Preference” or “No Selection” (these terms being alternative terms meaning the same thing), the system checks to determine if the customer has been assigned to a policy group. If the customer has been so assigned, the policy value assigned to the policy group is used.

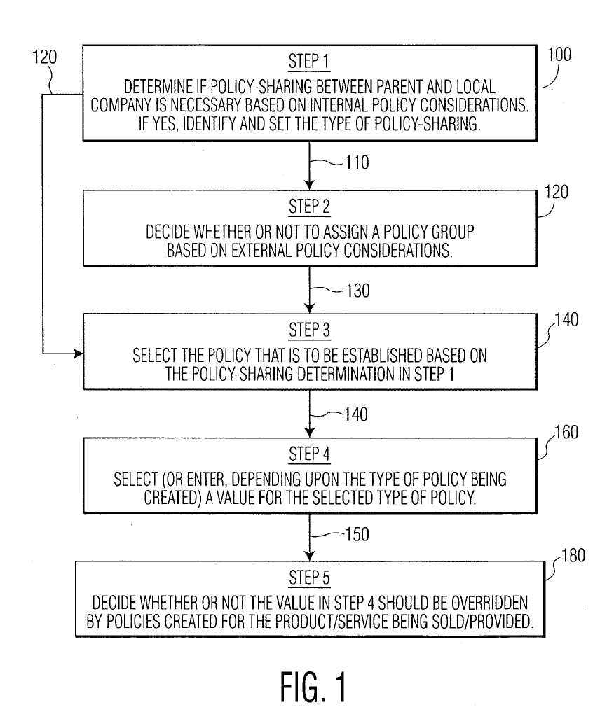

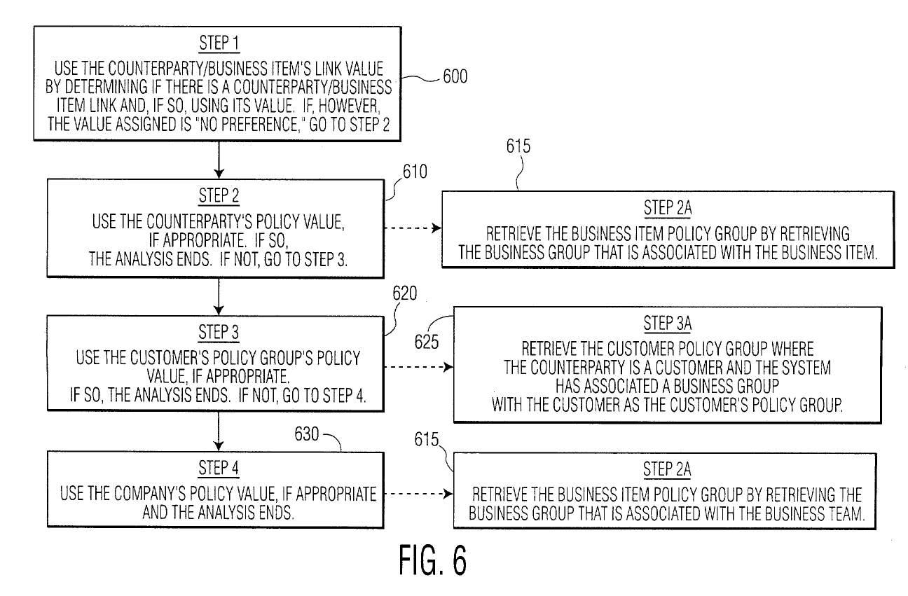

An exemplary embodiment of the steps for establishing the various business policies are shown in the flow charts identified as FIGS. 1 to 5. An exemplary embodiment of the steps for retrieving business policies for a particular business decision are shown in the flow charts identified as FIGS. 6 to 12.

Establishing a Business Policy for a Particular Business Role

Referring to FIG. 1, a flow chart showing a brief overview is shown of the steps for establishing a business policy for a particular business role. In Step 1, the system user determines if policy sharing between a parent company and the local company is necessary based on internal policy considerations of the two companies. This step is necessary where the user company (referred to as the “local company”) is owned and/or controlled by a parent company or where there are divisions within a company with a company hierarchy requiring that some aspects of the user division be controlled by a parent company.

Step 1 covers the situation where the user company is in a parent/child relationship with another entity. The user company must determine if the parent/child relationship between the two entities requires the user company to use only the parent's policy values for the particular transaction, whether the user company has the authority to use some of its own policies along with some of the parent company's policies, or whether it has the authority to use only its own policies. As shown in Step 1, appropriate entries are made in the establishing mode depending on how these questions are answered. After these entries are made, the user company proceeds to Steps 2 and 3. Of course, if there is no controlling company (that is, the user company is not a child to a parent company because the user company is not connected in any way to a controlling company), the user company would enter “local values only” and proceed to Steps 2 and 3 as indicated by reference numbers 110 and 120.

In Step 3, the user company selects the business policy that is to be established based on the policy-sharing determination made in Step 1. As explained above, Step 1 determines whether the user company will use Local Values only, Parent Values only, or both Local and Parent Values. In Step 3, therefore, the selected policy will be either the Local Policy, the Parent Policy, or a policy based on both Local and Parent policies.

In Step 2, the user company decides whether or not to assign a policy group based on external policy considerations such as whether business policies are assigned to a business item group or to a customer group. As noted in Step 2, an entry may or may not be entered into the system as part of Step 2. After the Step 2 decision has been completed, the process proceeds to Step 3 as indicated by reference number 130. Step 3 has already been discussed above. The Step 3 selection is made regardless of whether an entry was made in Step 2.

After Step 3 has been completed, the process proceeds to Step 4 as indicated by reference number 140. In Step 4, the user company selects a value for the type of policy that was selected to be established in Step 3. For some policies, the user will select from a predetermined series of alternatives that have been entered into the system. For other policies, the user will enter the value. For example, in the case of establishing credit policies, the user will enter a dollar amount for the credit limit. As another example, in the case of payment method, the user will have a choice of selecting from the following: electronic funds transfer, check, or credit card.

After Step 4, the user proceeds to Step 5 as shown by reference number 150. In Step 5, the user decides whether the value entered in Step 4 should be overridden by policies created for the product or service that is being sold or provided. For example, the user decides whether policies assigned to an item or to a customer should override the value established in Step 4.

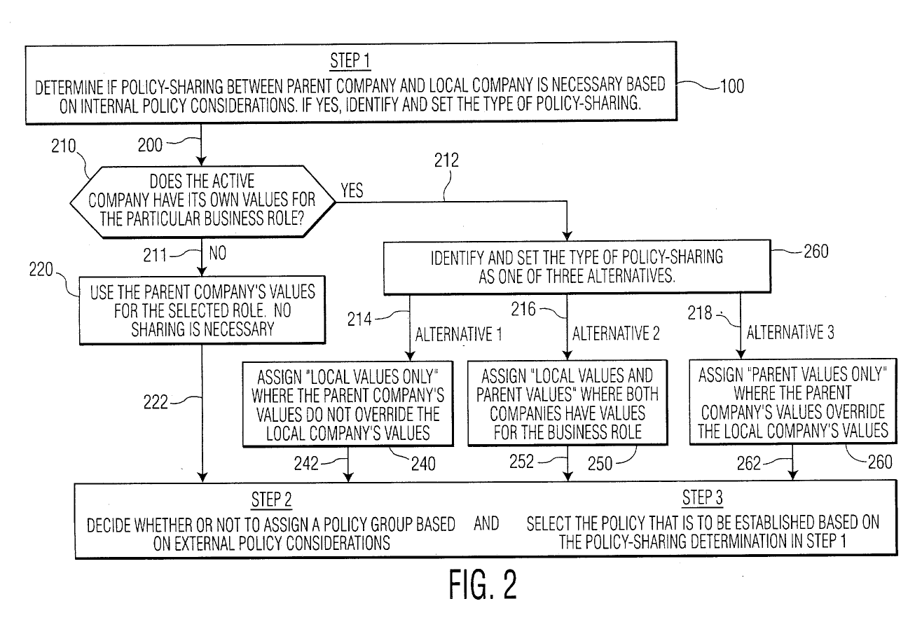

FIGS. 2 to 5 explain each step of the establishing process in greater detail.

FIG. 2 shows in detail the decisions and intermediate steps in completing Step 1. As shown by reference number 200, the first decision to be made is whether the active company (i.e., the user company) as its own values for the particular business role. This first decision is shown in decision block 210. If, as shown by reference number 211, the active company does not have its own values for the particular business role, the decision will be that the active company will use its parent company's values and no sharing of values is necessary as shown in block 220. Once that decision is made, the process proceeds to Steps 2 and 3 as shown by reference number 222. That is, the decisions required by Steps 2 and 3 will be made.

If, however, the question indicated by decision block 210 is “yes,” reference number 212 shows that the user must identify and set the type of policy-sharing as one of three alternatives as indicated in block 260. Reference numbers 214, 216, and 218 point to the three alternatives which are identified as blocks 240, 250, and 260, respectively.

Alternative 1 choice, indicated in block 240, permits the user company to assign “Local Values Only” where the parent company's values do not override local company's values. Alternative choice 2, indicated in block 250, permits the user company to assign “Local Values and Parent Values” where both companies have values for the business role. Alternative 3, indicated in block 260, permits the user company to, assign “Parent Values Only” where the parent company's values override the local company's values.

After the user company selects one of the alternatives indicated in blocks 240, 250, and 260, reference numbers 242, 252, and 262 show that the process proceeds to Steps 2 and 3. As indicated above, Step 2 may or may not result in an entry being made into the system. Nevertheless, Step 2 must be followed before Step 3 is completed. If no entry is made in Step 2, the process proceeds directly to Step 3 from Step 1. Even if an entry is made in Step 2, Step 3 proceeds based on the decision made in Step 1. Accordingly, reference numbers 222, 242, 252, and 262 are all shown as proceeding both to Step 2 and to Step 3.

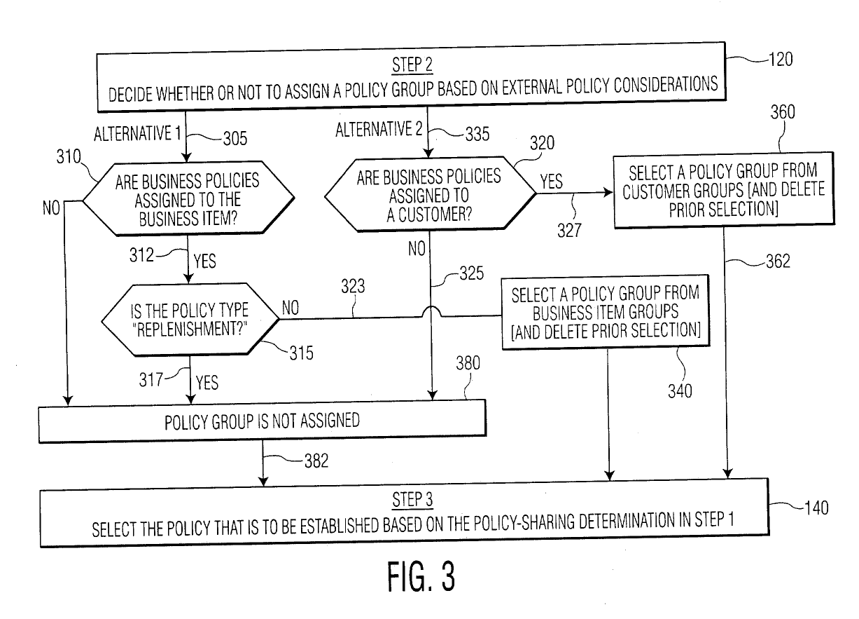

In Step 2, the user company decides whether or not to assign a policy group based on external policy considerations as indicated in block 120. The external policy considerations are whether business policies are assigned to the business item associated with the policy being established as indicated in decision block 310 and whether business policies are assigned to a customer as indicated in decision block 320. Reference numbers 305 and 335 indicates that Step 2 requires that the decisions in decision blocks 310 and 320 are to be made. It will be understood by those skilled in the art that there is no required order for the decisions in decision blocks 310 and 320 to be made. That is, the decision in block 310 can be made first; or, the decision in block 320 can be made first. In addition, the decisions in blocks 310 and 320 are alternative decisions designated in FIG. 3 as Alternative 1 and Alternative 2, respectively. It is contemplated in an exemplary embodiment that decisions on both alternatives will not be made simultaneously for the same business policy. However, as those skilled in the art will realize, another embodiment of the invention could allow decisions in blocks 310 and 320 to be entered simultaneously for the same business policy.

An exemplary embodiment will be discussed wherein the decision in block 310 is made first. In making the decision indicated in decision block 310, the user company decides whether business policies are assigned to the business item associated with the business policy being established. If the answer is no, as indicated by reference number 314, as policy group is not assigned as indicated in block 380 and the process proceeds to Step 382 as indicated by reference number 382.

On the other hand, if business policies are assigned to the business items, as indicated by reference number 312, the next decision to be made is whether the type of policy being established is “Replenishment.” An example of the Replenishment policy type is shown in FIG. 13 under the column labeled “Policy Type.” If as shown by decision block 315, if the type of policy being established is Replenishment, reference numbers 317 and 380 indicate that a policy group is not assigned and reference number 382 shows that the process proceeds to Step 3.

If the decision in block 315 is “no,” that is, that Replenishment is not the type of policy being established, then reference number 323 shows that the process proceeds to block 340 which directs the user to select a policy group from the applicable business item groups. If a business item group had previously been selected for the business item now being considered, and if the newly selected policy group is different from the previously selected business item group, block 340 shows that the current selection will automatically delete the previously selected group. After the selection indicated in block 340 has been made, reference number 342 shows that the process proceeds to Step 3.

In Alternative 2, decision block 320 shows that the user must decide whether business policies are assigned to a customer of the user company. If the answer is “no,” as indicated by reference numbers 325 and 380, a policy group is not assigned for the customer and the process proceeds to Step 3 as shown by reference number 382.

On the other hand, if the decision for block 320 is “yes,” as indicated by reference number 327, the user company selects a policy group from available customer groups as indicated by block 360. If a customer group had previously been selected for the customer now being considered, and if the newly selected policy group is different from the previously selected customer group, block 360 shows that the current selection will automatically delete the previously selected group. After the customer policy group has been selected, reference number 362 indicates that the process proceeds to Step 3.

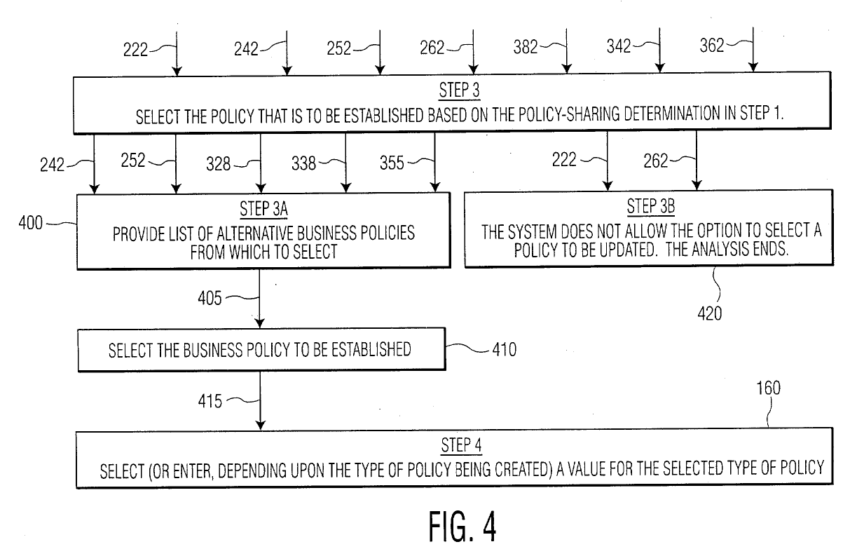

Step 3, block 140, is shown in FIG. 4. Reference numbers 222, 242, 252, and 262 are reminders that, in one aspect, Step 3 can proceed directly from Step 1 based upon the decisions made in Step 1 as shown in FIGS. 1 and 2. Reference numbers 382, 342, and 362 are reminders that, in another aspect, Step 2 decisions should be made before Step 3 proceeds. In Step 3, block 140, the user selects the policy that is to be established based on the policy-sharing determination made in Step 1. Referring first to Step 3B, block 420 shows the limiting effect of two of the alternative decisions made in Step 1 as indicated by reference numbers 222 and 262.

Referring back to FIG. 2, it is seen that reference number 222 resulted from the requirement to use the parent company's values as shown in block 220 and that reference number 262 resulted from the recognition that the parent company's values override the local company's values as shown in block 262. Step 3B, block 420 shows, therefore, that if parent company's values are used as shown in blocks 220 or 262, the system does not allow the option to select a policy to be updated and the analysis ends, as shown in block 420. On the other hand, reference numbers 242, 252, 382, 342, and 362 show that the process continues if the decisions preceding them were made. Thus, reference numbers 242 and 252 originated in FIG. 2 after entry of selections in either block 240 or 250, that local values had some input into the decision making process. It is further understood that any of the decisions in Step 2 require that the process continue to Step 3. The continuation of the process is indicated by Step 3A in block 400.

In Step 3A, block 400, the user company is presented with a list of alternative business policies from which to select. Afterward, reference number 405 indicates that the process proceeds to block 410 where the user company selects the business policy to be established, after which the process proceeds to Step 4 as indicated by reference numbers 415 and 160.

In Step 4, the user selects a value for the selected type of policy being established. Alternatively, and also depending upon the type of policy being established, a value may have to be entered, rather than be selected from a predetermined list of selections. As indicated by reference numbers 510 and 520, the first decision is based on the cumulative answers to three questions: (1) does the active company have its own business policy? (2) Does the active company use “Local Values Only?” (3) Are there available policy values for the policy? If the answers to all three questions are “yes,” reference numbers 525 and 550 indicate that the user company may not enter “No Preference” or “No Selection” as a possible value. On the other hand, if the answer to any of the three questions is “no,” then reference numbers 530 and 560 indicate that “No Preference” or “No Selection” is a possible value.

Regardless of whether the answer to decision block 520 is “yes” or “no,” reference numbers 555, 565, and 570 indicate that the user selects a value for the selected business policy from a list of possible business values or enters a value.

Finally, reference numbers 575 and 180 indicate that the user decides whether or not the value selected or entered in Step 4 should be overridden by policies created for the product or service (i.e., the item) being sold or provided. Once that decision has been made, the establishing process has been completed.

FIGS. 1 to 5 show one embodiment of a flow. The flow shown in FIGS. 1 to 5, and the order of the flow, has been used to show one way in which the system may be used. It will be understood, however, that, in most implementations of the “establish” phase of the invention, entries need not be entered into the system in the order shown in these figures. Therefore, for example, data pertaining to Step 4 may be entered before data pertaining to Step 3 and before data pertaining to Step 1. As another example, data pertaining to Step 2 may be entered before data pertaining to Step 1.

The only two steps which must be implemented in the order shown are Steps 1 and 3. With respect to those two steps, data pertaining to Step 1 must be entered before data can be entered for Step 3.

FIGS. 14 to 18 will now be used to show exemplary embodiments of how the flow charts in FIGS. 1 to 5 are used to establish different values for various aspects of establishing credit related policies.

FIG. 14 shows a computer screen which is presented to the user company that wants to establish default entries for its credit policies. The items in column 1400 are presented to the user by default for the establishment of the user's credit policies. All of the items in column 1402, except “Policy Value” are presented to the user as choices that the user can make during the establishing process. The term “Policy Value” is presented to the user by default. The term “Policy Value” means that the items below it are the values which will be entered by the user. The items in column 1404 are the default values which have previously been entered into the system for this user corresponding to the default items in column 1400. Thus, for example, the current default value for the item “Payment Terms” is “Discount if paid in 10 days; due in 30.” If the user were to change the values in column 1402, the entries in column 1404 would automatically change to match the new entry in column 1402. The blocks in column 1406 all fall under the term “Defer to Item.” In column 1404, the user determines which, if any, of the operative values should be overridden by the values set on the corresponding item; that is, the product or service being sold or provided.

The 1400/1406 intersection corresponds to Steps 1 and 3 in that the system asks the user to determine if policy sharing between the parent company and the local company is necessary. The drop down screen (not shown) in column 1402 gives the user the three choices shown in blocks 240, 252, 262 in FIG. 2. In the screen shown in FIG. 14, the user has selected and entered “Local and parent values.” Since Step 2 does not apply to this set of policy values, it does not appear on the screen.

Beginning with the 1400/1408 intersection, the system provides the user with a list of alternative business policies from which to select as shown in Step 3A, block 400, FIG. 4. The list of alternative business policies are identified at the intersection of column 1400 with rows 1410-1422. The user then has the choices that are made available through the drop-down screens in the places intersected by column 1402 and rows 1410-1422; selects which of the business policies to establish as shown in block 410, FIG. 4; and selects (or enters) the values as shown in Step 4, blocks 160 and 570. Policy values in rows 1410-1420 must be selected from specific choices provided by the system. Policy values in row 1422 is entered by the user.

The drop down screen in row 1410 provides the following choices (not shown): Discount if paid in 10 days; due in 30, Discount if paid in 45 days; due in 60, Payment in full; No Discount. The drop down screen in row 1412 provides the following choices (not shown): Electronic Funds Transfer, Check, or Credit Card. The drop down screen in row 1414 provides the following choices (not shown): Credit Check, Do Not Credit Check. The drop down screen in row 1416 provides the following choices (not shown): On credit hold, not on credit hold. The drop down screen in row 1418 provides the following choice (not shown): Open orders plus receivables<=limit. The drop down screen in row 1420 provides the following choice (not shown): Extended net price plus tax.

Column 1406 implements Step 5, block 180. The user company decides whether the policies in Step 4 (the policy values entered in column 1402 and evidenced as default values in column 1404) should be overridden by the policies set for the corresponding items. The user indicates that the column 1402/1404 policy values should be overridden by checking the appropriate boxes in column 1406. Thus, for example, the block at intersection 1406/1410 has been checked indicating that the policy value for payment terms is deferred to (overriden by) the policy value for the corresponding item. On the contrary, the deferment block is not checked at intersection 1406/1414, thereby indicating that check credit does not defer to the corresponding item's value.

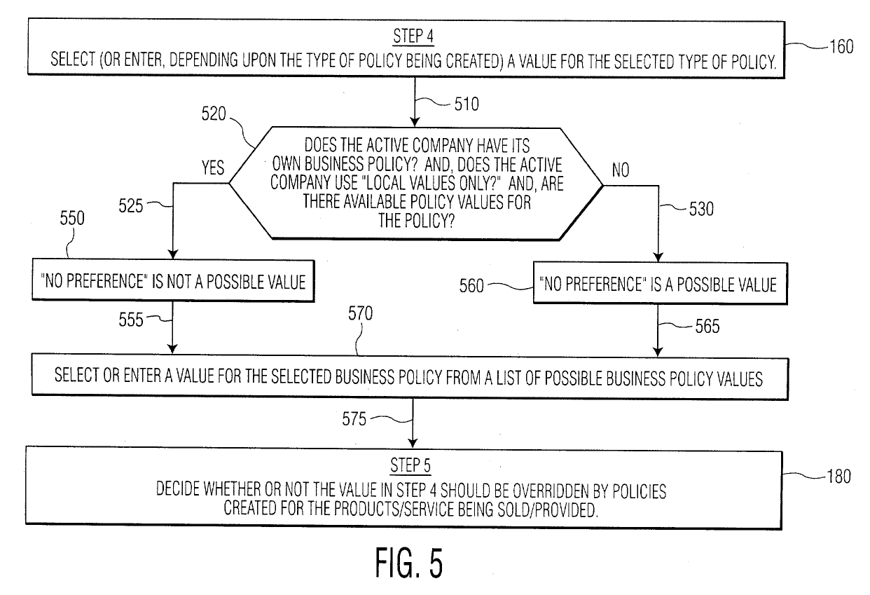

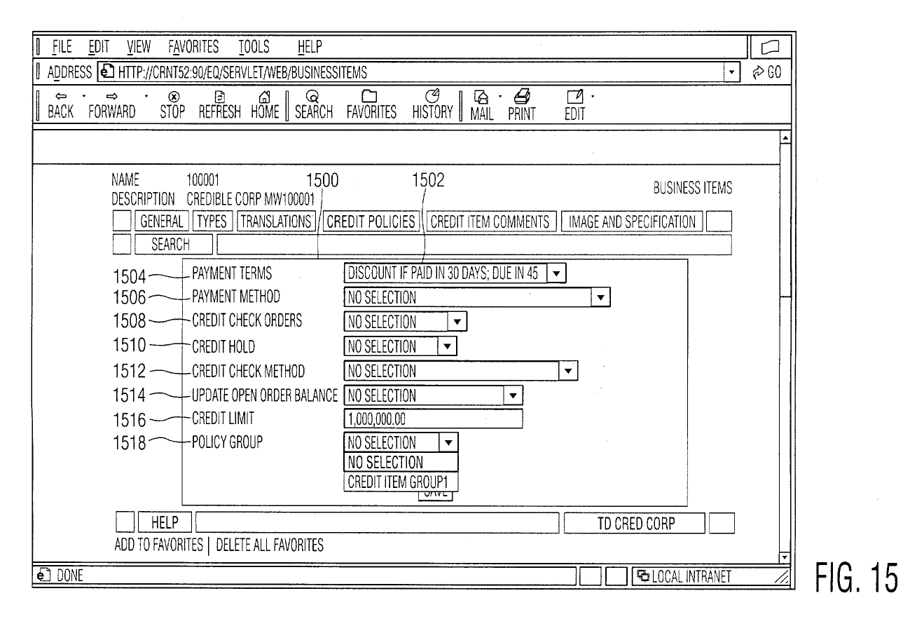

FIG. 15 is an exemplary embodiment showing the establishment of values for a credit item. In this case, Step 1 does not apply. The process begins with Steps 2 and 3. Here, the policy is a business item; more particularly, a credit item. Once credit item is entered into the system, the user is provided with the information in columns 1500 and 1502. The entry at the 1500/1518 intersection is based on Step 2 and block 570 in FIG. 5. The entries in all intersections except 1502/1516 are made from predetermined choices in drop down screens. Except for the drop down screen at the 1502/1518 intersection, the choices are not shown. “No Selection” is the equivalent of “No Preference” in the flow charts. The drop down screen in row 1504 provides the following choices (not shown): Discount if paid in 10 days; due in 30, Discount if paid in 45 days; due in 60, Payment in full; No Discount. The drop down screen in row 1506 provides the following choices (not shown): Electronic Funds Transfer, Check, or Credit Card. The drop down screen in row 1508 provides the following choices (not shown): Credit Check, Do Not Credit Check. The drop down screen in row 1510 provides the following choices (not shown): On credit hold, not on credit hold. The drop down screen in row 1512 provides the following choice (not shown): Open orders plus receivables<=limit. The drop down screen in row 1514 provides the following choice (not shown): Extended net price plus tax.

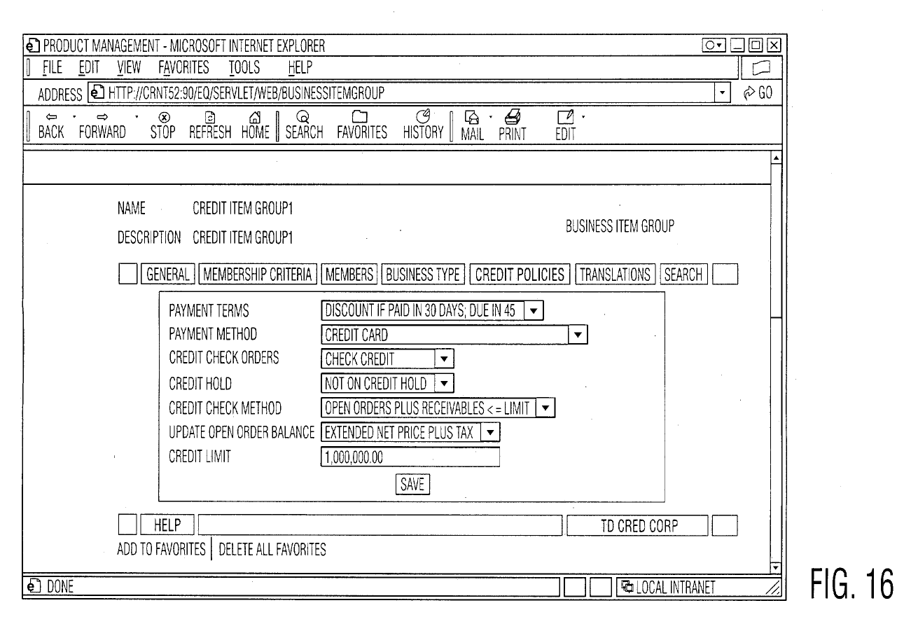

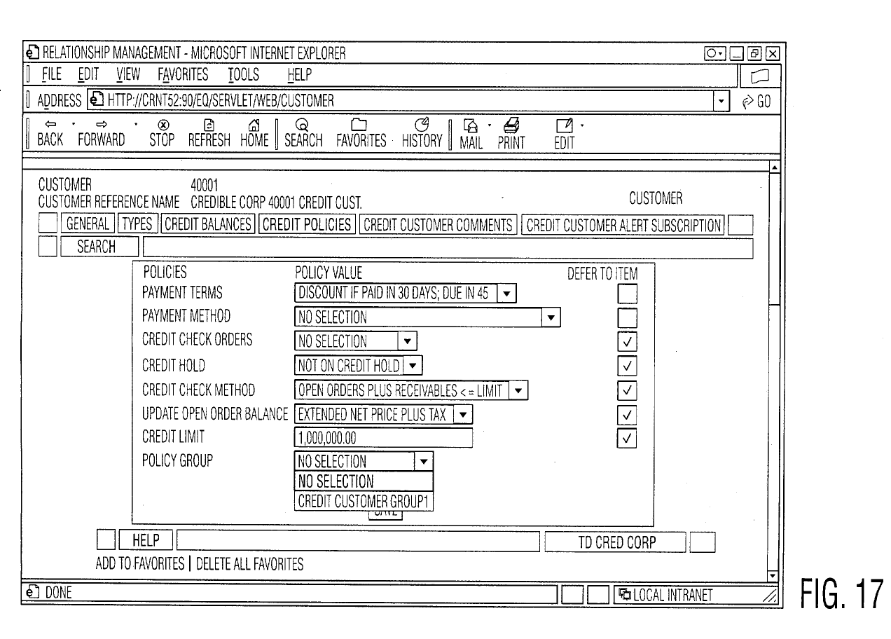

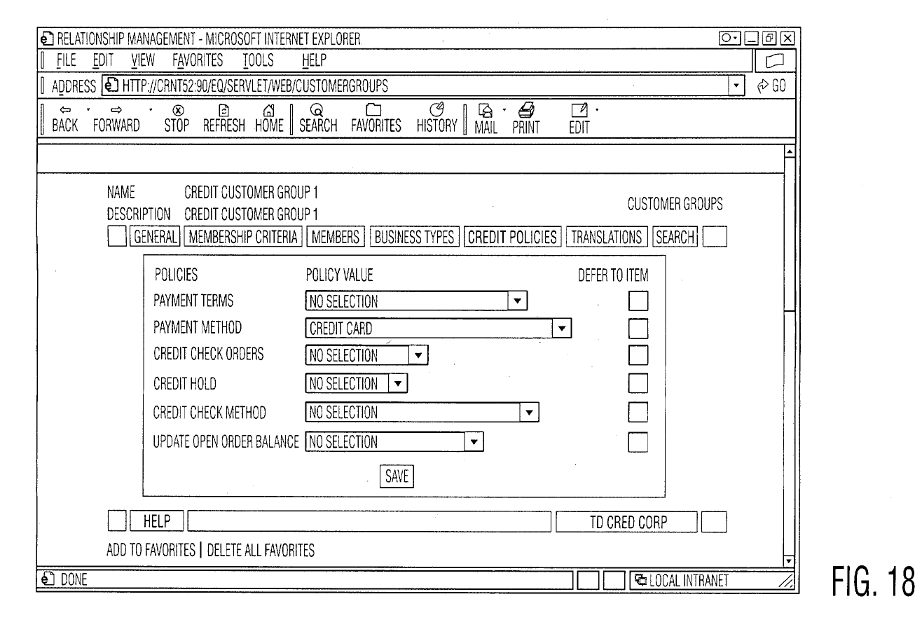

FIG. 16 illustrates an exemplary embodiment of an establish screen for establishing credit policies for a credit item group. FIG. 17 illustrates an exemplary embodiment of an establish screen for establishing credit policies for a credit customer. FIG. 18 illustrates an exemplary embodiment of an establish screen for establishing credit policies for a credit customer group.

It will be understood by those skilled in the art that policies, using the method described in FIGS. 1 to 5, and using screens similar to those shown in FIGS. 14 to 18 may be used to establish policies for all of the policy types, counterpartys, and business item types shown in FIG. 13. It will be understood by those skilled in the art that the choices and drop down screens may change depending upon circumstances.

Retrieving a Business Policy for a Particular Business Decision

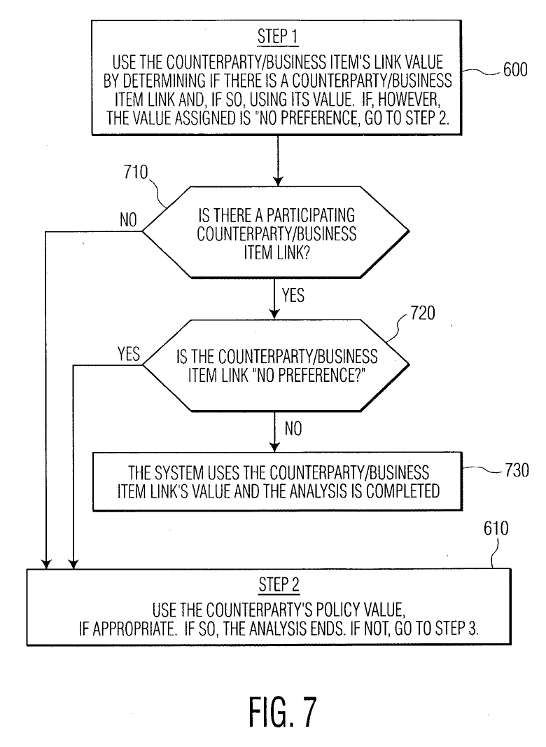

Although entries into the establish aspect of the invention may be made in more than one order and without any priority, the retrieve aspect of the invention operates in accordance with an algorithm by looking at what has previously been established and operating on the previously established entries in a particular order. With some exceptions, the retrieve aspect of the invention is done in accordance with a priority scheme. Although all parts of the priority list may not apply to all retrievals, the system will search the stored information to determine if all parts are present and must be accounted for. The highest priority, in other words, the highest importance, is given to the counterparty/business item link, a term that will be defined in connection with FIG. 7. The next highest priority is the item, which comes into play only if “defer to item” was entered into the system during the establish aspect of the invention. The next two priorities are the customer and then the company.

FIG. 6 shows the steps that the system may follow when retrieving a business policy for particular business decision. The “retrieving” aspect of the invention is triggered when the user company inputs information pertaining to a particular business decision and then asks the system to analyze the information based upon the data previously entered during the “establish” phase of the invention.

First, Step 1, block 600, the system uses the counterparty/business item's link value by determining if there is a counterparty/business item link. If there is a counterparty/business item link, the system uses its value. If, however, there is no counterparty/business item link, the system begins with Step 2. Similarly, if the value assigned to the counterparty/business item link is “No preference,” then the system goes to Step 2. The meaning of the term “counterparty/business item link” will be explained in connection with FIG. 7.

In Step 2, block 610, the system uses the counterparty's policy value, if appropriate. If it is appropriate to use the counterparty's policy value, that policy value is used and the analysis ends. At the completion of Step 2, the system will either go to Step 2A, block 615, or to Step 3, block 3, depending upon whether the counterparty has been established such that it will defer to item and the value assigned to the item is ‘No preference.’ That is, if the counterparty has been established such that it will defer to item and the value assigned to the item is ‘No preference,’ the system will go to step 2A. If, however, the counterparty has been established such that it does not defer to item, the system will go directly to step 3. In Step 2A, block 615, the system retrieves the business item policy group by retrieving the business group that is associated with the business item.

In Step 3, block 620, the system uses the customer's policy group's policy value, if appropriate. Step 3A, block 625, is a substep of Step 3 and applies where the system retrieves the customer policy group where the counterparty is a customer and the system has associated a business group with the customer as the customer's policy group. If the system uses the customer's policy group's value, the analysis ends and that value is provided to the user. If the system does not use the customer's policy group's policy value, the system goes to Step 4, block 630. Alternatively, the system goes directly from Step 2 or Step 2A to Step 4 if the counterparty is not a customer.

After Step 2 or Step 3, whichever is appropriate, the system goes to Step 4, block 630. In Step 4, the system uses the company's policy value, if appropriate. It may not be appropriate to use the company's policy value when the company has been established such that it first should defer to the item for its policy value. If the company has been established such that it should defer to the item for its policy value and the value assigned is “No preference,” the system will return to Step 2A, block 615, and retrieve the business item policy group by retrieving the business group that is associated with the business item. It will be understood that Step 2A may follow Step 4 only if Step 2A did not previously follow Step 2. If Step 2A follows Step 2, Step 2A will not be retrieved again following Step 4 because the system will already have retrieved Step 2A.

Referring to FIG. 7, sub-steps for Step 1, block 600, are shown. Before discussing FIG. 7 in detail, we will first explain the term “counterparty/business item link.” The term counterparty/business item link occurs at the intersection of the value for the counterparty and the value set for a pertinent business item. For example, a possible counterparty may be a warehouse for which a policy value may have been set during the establish phase of the invention. For a particular warehouse, the established policy would be to transport something from this warehouse by truck. At the same time, a policy value may have been set for a particular item. For the particular item, the established method of transport may be by train. The system therefore has to deal with these two different means of transport when the particular item is to be transported from the particular warehouse. The counterparty/business item link is therefore the intersection of these conflicting policy values. When the system identifies the link, the system allows the user to override the policy assigned to the warehouse and the policy assigned to the item.

Step 1, block 600, shown in FIG. 7, shows how the system implements the counterparty/business item link. In Step 1, the system first determines if there is a participating counterparty/business item link as shown in decision block 710. If the answer is “no,” the system goes to Step 2, block 610. If the answer to decision block 710 is “yes,” the system determines of the counterparty/business item link is “No preference” as shown in decision block 720. If the answer is “yes,” (that is, the system does not prefer to use the counterparty/business item link), the system goes on to Step 2. If, however, the answer is “no” (that is, the system does prefer to use the link's policy value), the system uses the link's value and the analysis is completed, as shown in block 730. As discussed above, implementation of block 730 allows the user to override the policy values assigned to the counterparty and the business item.

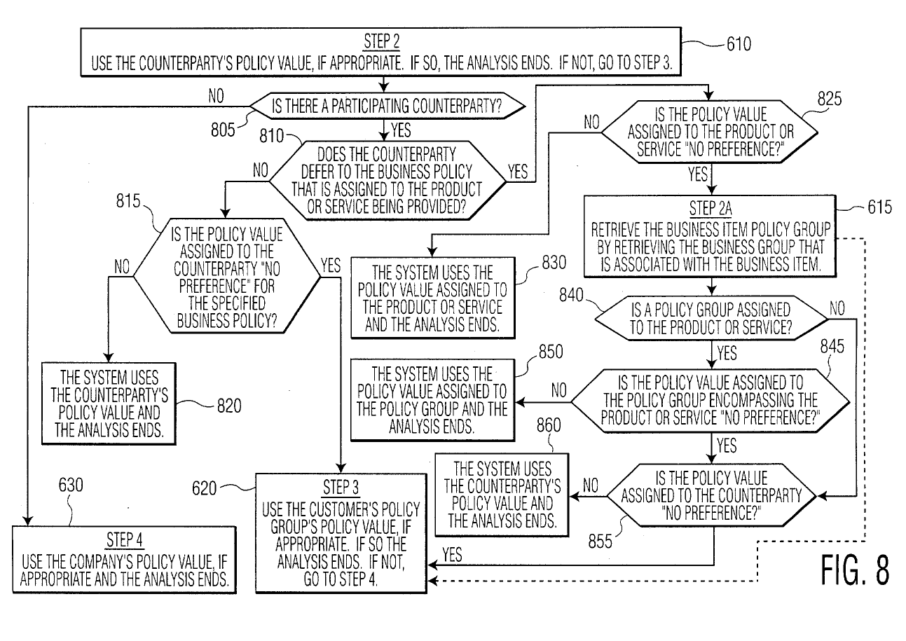

Referring to FIG. 8, the flow of the algorithm is shown for Step 2, block 610. In Step 2, the system determines, in decision block 805, if there is a participating counterparty. If the answer to the question is “no,” the system proceeds to Step 4, block 630. If the answer to decision block 805 is “yes,” the system proceeds to decision block 810 which determines if the counterparty defer to the business policy that is assigned to the product or service being provided. That is, decision block 810 asks if the counterparty defers to the policy value assigned to an item. If the answer to decision block 810 is “no,” the system proceeds to decision block 815 which determines if the policy value assigned to the counterparty is “No preference” for the specified business policy. If the answer is “no” (that is, the system does prefer to use the policy value assigned to the counterparty for the specified business policy), the system uses the counterparty's policy value and the analysis ends as shown in block 820.

If the answer to decision block 815 is “yes” (that is, the system does not prefer to use the policy value assigned to the counterparty for the specified business policy), the system proceeds to Step 3, block 620.

Returning to the explanation of decision block 810, if the answer is “yes,” the system proceeds to decision block 825 where the system determines if the policy value assigned to product or service (i.e., the item) is “No preference.” If the answer to decision block 825 is “no” (that is, the system prefers the policy value assigned to the product or service (i.e., the item), the system proceeds to block 830 and uses the policy value assigned to the product or service and the analysis ends.

If the answer to decision block 825 is “Yes,” the system proceeds to Step 2A, block 835. The process of Step 2A is described in detail below. After Step 2A is completed, the system proceeds to decision block 840 where it determines if a policy group has been assigned to the product or service. If the answer to this question is “yes,” the systems proceeds to decision block 845 which determines if the policy value assigned to the policy group encompassing the product or service is “No preference.” If the answer to decision block 845 is “no” (i.e., the system does prefer the policy value assigned to the policy group encompassing the product or service), the system proceeds to block 850 where the system uses the policy value assigned to the policy group and the analysis ends.

If the answer to decision block 845 is “yes,” the system proceeds to decision block 855 which asks if the policy value assigned the counterparty is “no preference.” If the answer to decision block 855 is “no,” the system proceeds to block 860 where the system uses the counterparty's policy value and the analysis ends. If the answer to decision block 855 is “yes,” the system proceeds to step 3.

Returning to decision block 840, if the answer to decision block 840 is “no,” the system proceeds to decision block 855, where the system determines if the policy value assigned to the counterparty is “No preference.” If the answer to decision block 855 is “no,” the system uses the counterparty's policy value and the analysis ends, as shown in block 860. If, however, the answer to decision block 855 is “yes,” the system proceeds to Step 3, block 620. Alternatively, after step 2A is performed, the system may proceed directly to step 3. This happens if there is no business group associated with the business item as the business item's policy group.

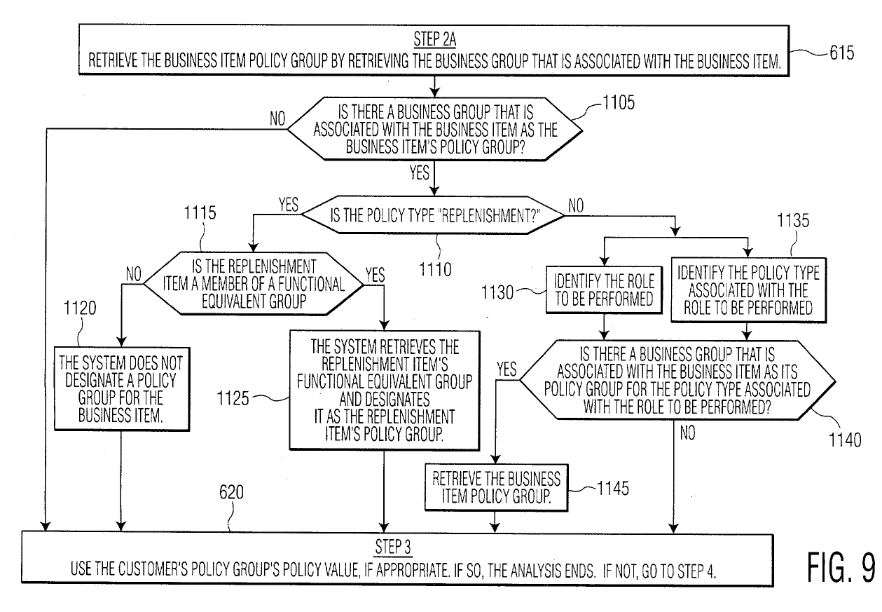

Referring to FIG. 9, we will now describe Step 2A, block 615. First, the system determines if there is a business group that is associated with the business item as the business item's policy group, as shown in decision block 1105. If the answer to decision block 1105 is “no,” the system proceeds immediately to Step 3, block 620. If the answer to decision block 1105 is “yes,” the system determines if the policy type is replenishment, decision block 1110. If the answer to decision block 1110 is “yes,” the system determines if the replenishment item is a member of a functional equivalent group, as shown in decision block 1115. If the answer to decision block 1115 is “no,” the system does not designate a policy group for the business item as shown in block 1120 and the system proceeds to Step 3. If, however, the answer to decision block 1115 is “yes,” the system retrieves the replenishment item's functional equivalent group and designates it as the replenishment item's policy group, block 1125, and proceeds to Step 3.

Returning to decision block 1110, if the answer is “no,” the system identifies the role to be performed, block 1130, and identifies the policy type associated with the role to be performed, block 1135. Once the procedures of blocks 1130 and 1135 have been performed, the system determines if there is a business group that is associated with the business item as its policy group for the policy type associated with the role to be performed, as shown in decision block 1140. If the answer to decision block 1140 is “no,” the system proceeds immediately to Step 3. On the other hand, it the answer to decision block 1140 is “yes,” the system retrieves the business item policy group as shown in block 1145 and then proceeds to Step 3, block 630.

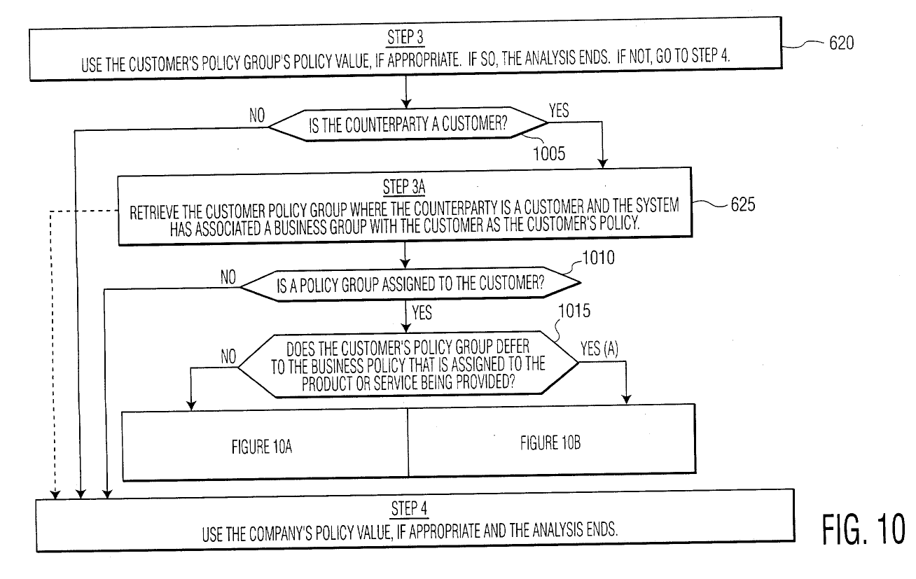

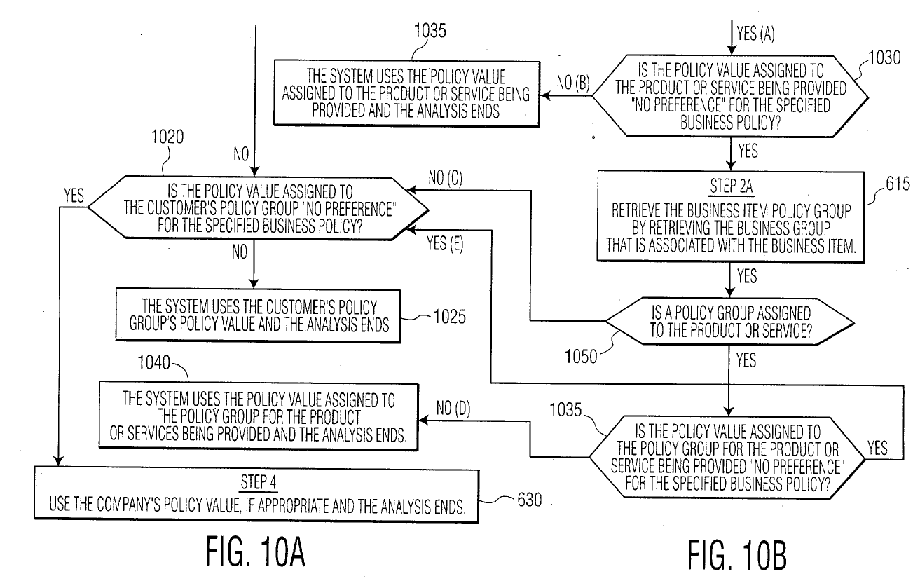

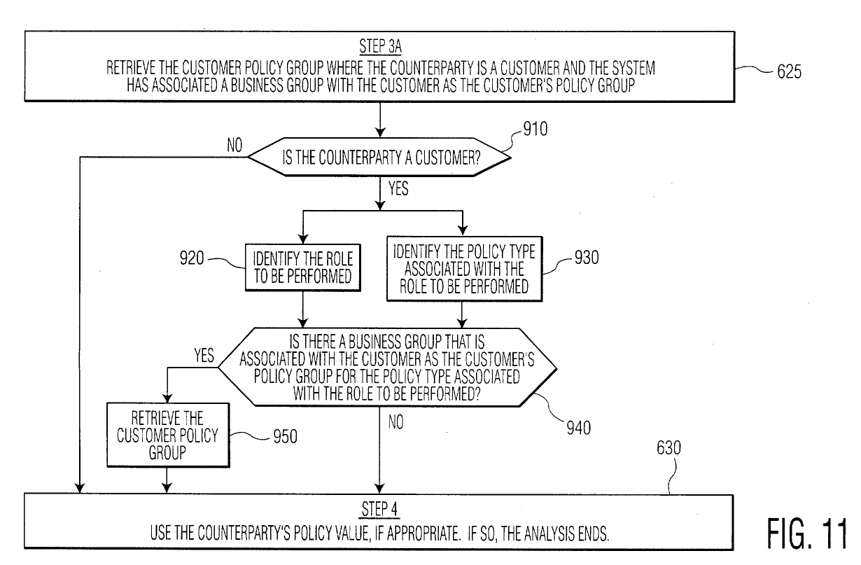

Referring to FIG. 10, Step 3 will now be described. First, the system determines whether the counterparty is a customer in decision block 1005. If the answer to decision block 1005 is “no,” the system proceeds immediately to Step 4, block 630. If the answer to decision block 1005 is “yes,” the system proceeds to Step 3A, block 620. Step 3A will be described below in connection with FIG. 11. After Step 3A has been completed, the system proceeds to decision block 1010 which determines if there is a policy group assigned to the customer. If the answer to decision block 1010 is “no,” the system proceeds immediately to Step 4.

If the answer to decision block 1010 is “yes,” the system determines if the customer's policy group defers to the business policy that is assigned to the product or service (i.e., the item) being provided. If the answer is “no,” the system determines if the policy value assigned to the customer's policy group is “No preference” for the specified business policy, decision block 1020. If the answer to decision block 1020 is “yes,” the system proceeds to Step 4, block 630. If the answer to decision block 1020 is “no,” the system uses the customer's policy group's policy value and the analysis ends, as shown in block 1025.

Returning to decision block 1015, if the answer is “no,” the system determines if the policy value assigned to the produce or service (i.e., the item) is “No preference” for the specified business policy, decision block 1020. If the answer to decision block 1020 is “no,” the system uses the policy value assigned to the customer's policy group and the analysis ends, as shown in block 1025. However, if the answer to decision block 1015 is “yes,” the system determines if the policy value assigned to the product or service being provided (i.e., the item) is “No preference” for the specified business policy. If the answer to decision block 1030 is “no,” the system uses the policy value assigned to the product or service being provided and the analysis ends, as shown in block 1035.

If the answer to decision block 1030 is “yes,” the system implements Step 2A, block 615 in the manner previously described with respect to FIG. 9. The explanation of FIG. 9 is incorporated by reference. After Step 2A has been completed, the system determines if a policy group is assigned to the product or service (i.e., the item). If the answer to decision block 1050 is “no,” the system proceeds to decision block 1020. The operation of decision block 1020 and block 1025 has been previously explained. The previous explanation is incorporated herein by reference.

If the answer to decision block 1050 is “yes,” the system determines if the policy value assigned to the policy group for the product or service being provided is “No preference” for the specified business policy, decision block 1035. If the answer to decision block 1035 is “no,” the system uses the policy value assigned to the policy group for the produce or service being provided and the analysis ends, as shown in block 1040. If the answer to decision block 1035 is “yes,” the system proceeds to decision block 1020. The operation of decision block 1020 and block 1025 has been previously explained. The previous explanation is incorporated herein by reference.

Referring to FIG. 11, Step 3A will now be described. To implement Step 3A, the system proceeds to decision block 910 to determine if the counterparty is a customer. If the answer is “no,” the system immediately proceeds to Step 4, block 630. If the answer to decision block 910 is “yes,” the system proceeds to blocks 920 and 930. In block 920, the system identifies the role to be performed. In block 930, the system identifies the policy type associated with the role to be performed. After both identifications in blocks 920 and 930 have been made, the system proceeds to decision block 940 where the system determines if there is a business group that is associated with the customer as the customer's policy group for the policy type associated with the role to be performed. If the answer to decision block 940 is “no,” the process proceeds to Step 4. If the answer is “yes,” the system proceeds to block 950, retrieves the customer policy group and then proceeds to step 4.

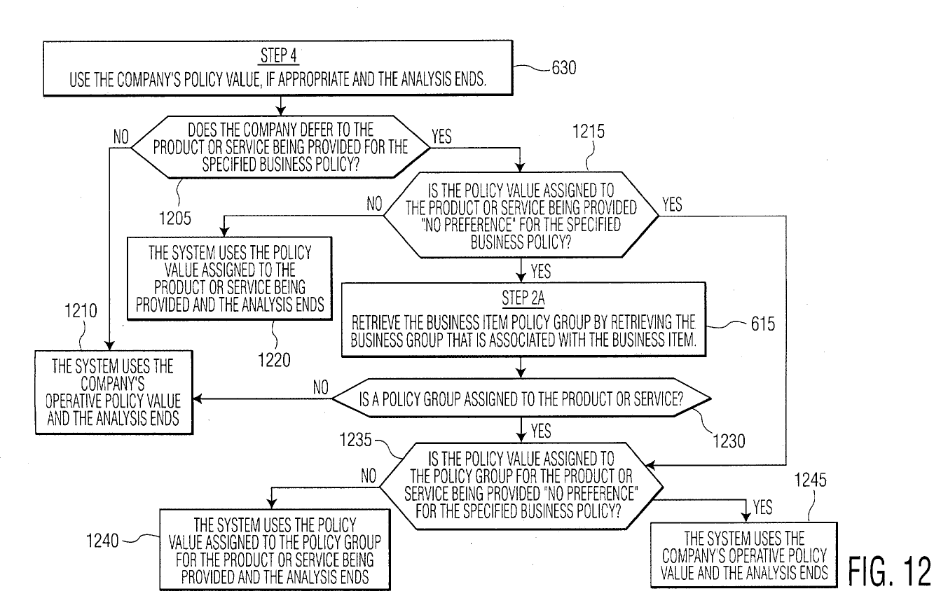

Referring to FIG. 12, Step 4 will now be described. First, the system determines if the company defers to the product or service (i.e., the item) being provided for the specified business policy, as shown in decision block 1205. If the answer to decision block 1205 is “no,” the system uses the company's operative policy value and the analysis ends, as shown in block 1210. If, however, the answer to decision block 1205 is “yes,” the system determines if the policy value assigned to the product or service being provided is “No preference” for the specified business policy, as shown in decision block 1215. If the answer to decision block 1215 is “no,” the system uses the policy value assigned to the product or service (i.e., the item) being provided and the analysis ends, as shown in block 1220.

Alternatively, after step 3A is performed, the system may proceed directly to step 4 as shown by the dotted line. This happens if there is no customer group associated with the customer as the customer's policy group.

If, however, the answer to decision block 1215 is “yes,” the system causes two things to happen. First, the system proceeds to Step 2A, block 1225, which has previously been described in connection with FIG. 9. The explanation of FIG. 9 is incorporated herein by reference. After Step 2A, the system determines if there is a policy group assigned to the product or service (i.e., the item), as shown in decision block 1230. It the answer to decision block 1230 is “no,” the system uses the company's operative policy value and the analysis ends, as shown in block 1210. If the answer to decision block 1230 is “yes,” the system determines if the policy value assigned to the policy group for the produce or service (i.e., the item) being provided is “No preference” for the specified business policy, as shown in decision block 1235. If the answer to decision block 1235 is “no,” the system uses the policy value assigned to the policy group for the produce or service being provided and the analysis ends, as shown in block 1240. If, however, the answer to decision block 1235 is “yes,” the system uses the company's operative policy value and the analysis ends, as shown in block 1245.

It is understood that the present invention is susceptible to many different variations and combinations and is not limited to the specific embodiments shown in this application. In addition, it should be understood that each of the elements disclosed all do not need to be provided in a single embodiment, but rather can be provided in any desired combination of elements when desired. It will also be appreciated that a system in accordance with the invention can be constructed in whole or in part from special purpose hardware or from conventional general purpose hardware or any combination thereof, any portion of which may be controlled by a suitable program. Any program may in whole or in part be comprised of or be stored on a system in a conventional manner, or remain whole or in part be provided into the system over a network or other mechanism for transferring information in a conventional manner. Accordingly, it is understood that the above description of the present invention is susceptible to considerable modifications, changes, and adaptations are intended to be considered within the scope of the present invention, which is set forth by the appended claims.

What is claimed:

1. A method for guiding decision making related to at least one business role, said method comprising the steps of:
(a) retrieving at least one business policy for at least one business role;
(b) determining and retrieving established factors and established relative weights assigned to said established factors for the at least one business role; and
(c) operating upon the retrieved at least one business role, the established factors, and the established relative weights in accordance with an algorithm.

2. A method for guiding decision making related to at least one business role, said method comprising the steps of:
(a) specifying the at least one business role;
(b) establishing at least one business policy for the at least one business role, said establishing the at least one business policy including the steps of:
(i) establishing factors to be considered; and
(ii) establishing relative weights to be assigned to each of the factors;
(c) retrieving the at least one business policy for the at least one business role;
(d) determining and retrieving the established factors and the established relative weights assigned to said factors for the at least one business role;
(e) operating upon the retrieved at least one business policy, the established factors, and the established relative weights in accordance with an algorithm.

3. The method of claim 2, wherein the step of specifying the at least one business role includes the step of selecting said at least one business role from the group consisting of creditor, fulfillment planner, invoicer, pricer, purchaser, replenishment planner, and seller.

4. The method of claim 2, wherein the step of establishing the at least one business policy for the at least one business role includes the step of selecting said at least one business policy from the group consisting of credit, fulfillment planning, replenishment, invoicing, pricing, purchasing, and selling.

5. The method of claim 2, wherein the step of establishing the factors to be considered includes the step of selecting at least one factor from the group consisting of credit customer, ship-to customer/warehouse, bill-to customer, pricing customer, buy-from supplier, sold-to customer, credit item, planning item, invoicing item, pricing item, purchasing item, replenishment item, and selling item.

6. The method of claim 5, wherein the step of establishing the relative eights to be assigned to each of the factors includes the step of assigning at least one numerical value to the at least one selected factor from the group consisting of credit item, planning item, invoicing item, pricing item, purchasing item, replenishment item, and selling item.

7. The method of claim 2, wherein the algorithm operates upon the factors in accordance with a priority scheme.

8. The method of claim 2, further comprising the steps of:
determining if a first company has established a first set of values for a business role;
determining if a parent company of said first company has established a second set of values for the business role;
selecting one of the first set of values, the second set of values, and a combination of the first set of values and the second set of values.

9. The method of claim 8 further comprising the steps of:
choosing a value from one of the first set of values, the second set of values, and the combination of the first set of values and the second set of values; and
determining whether to override the chosen value with one of a policy for a product to be sold and a policy for a service to be provided.

10. The method of claim 2, further comprising the steps of:
determining at least one of whether there is a particating counterparty, whether there is a business group that is associated with a business item, whether the particating counterparty is a customer, whether a company defers to one of a product and a service being provided; and
using at least one of a counterparty/business item's link value, a counterparty's policy value, a customer's policy group's value, and a company's policy value.

11. A program storage device readable by machine, tangibly embodying a program of instructions executable by the machine to perform method steps for
(a) specifying the at least one business role;
(b) establishing at least one business policy for the at least one business role, said establishing the at least one business policy including the steps of:
(i) establishing factors to be considered; and
(ii) establishing relative weights to be assigned to each of the factors;
(c) retrieving the at least one business policy for the at least one business role;
(d) determining and retrieving the established factors and the established relative weights assigned to said factors for the at least one business role;
(e) operating upon the retrieved at least one business policy, the established factors, and the established relative weights in accordance with an algorithm.

12. The program storage device of claim 11, wherein the device further performs method steps for
determining if a first company has established a first set of values for a business role;
determining if a parent company of said first company has established a second set of values for the business role;
selecting one of the first set of values, the second set of values, and a combination of the first set of values and the second set of values.

13. The program storage device of claim 11, wherein the device further performs method steps for
choosing a value from one of the first set of values, the second set of values, and the combination of the first set of values and the second set of values; and
determining whether to override the chosen value with one of a policy for a product to be sold and a policy for a service to be provided.

14. The program storage device of claim 11, wherein the device further performs method steps for
determining at least one of whether there is a particating counterparty, whether there is a business group that is associated with a business item, whether the particating counterparty is a customer, whether a company defers to one of a product and a service being provided; and
using at least one of a counterparty/business item's link value, a counterparty's policy value, a customer's policy group's value, and a company's policy value.
